(19) United States
(12) Patent Application Publication
(10) Pub. No.: US 2026/0170354 A1
(43) Pub. Date: Jun. 18, 2026

(54) ROBUST DECISION TREES

(71) Applicant: Intuit Inc., Mountain View, CA (US)

(72) Inventors: Idan HABLER, Be’er Ya’akov (IL); Yael MATHOV GOME, Be’er Sheva (IL); Ron BITTON, Hod Hasharon (IL); Itsik Yizhak MANTIN, Shoham (IL)

(73) Assignee: Intuit Inc., Mountain View, CA (US)

(21) Appl. No.: 18/984,720

(22) Filed: Dec. 17, 2024

(51) Int. Cl. G06N 5/01

(52) U.S. Cl. CPC G06N 5/01

(57) ABSTRACT

Systems and methods for generating robust decision trees are disclosed herein. An example method is performed by one or more processors of a computing system. The example method may include receiving, over a communications network from a computing device, a transmission including a dataset including a set of features. The example method may also include generating a trustworthiness score for each respective feature of the set of features, each trustworthiness score indicative of at least one of a degree of reliability associated with a source of the respective feature or a degree of difficulty associated with manipulating values for the respective feature. The example method may also include generating a robust decision tree for the dataset based on the set of features and their corresponding trustworthiness scores.

### TECHNICAL FIELD

This disclosure relates generally to decision trees, and specifically to generating robust decision trees.

### DESCRIPTION OF RELATED ART

Artificial intelligence (AI) refers to the development of computer systems capable of performing tasks traditionally requiring human intelligence, such as learning, problem-solving, and decision-making. Many computer-based applications now integrate AI to improve functionality and user experience, with uses in fields like healthcare, automation, personal assistants, recommendation systems, and data analysis. Many AI applications use decision trees to model complex decision-making processes and classify or predict outcomes based on input features. For example, a decision tree may be integrated into a computer-based AI medical diagnosis application that can use the decision tree to predict a likelihood of a patient having a particular disease based on features like the patient's symptoms, medical history, and/or test results.

However, decision trees and their associated applications are vulnerable to various types of adversarial attacks, such as data poisoning, feature falsification, feature manipulation, and adversarial examples. Each of these attack vectors presents a particular type of threat to the reliability and security of a decision-tree-based application. For example, feature manipulation attacks may exploit vulnerabilities stemming from heterogeneous data sources by altering specific input features to misclassify instances, thereby degrading the accuracy of results generated based on the decision tree and potentially leading to unreliable or even malicious outputs.

To mitigate such vulnerabilities in decision trees and their corresponding applications, developers and security experts have employed various techniques. Such techniques have focused on preparing training data before it is used or adjusting procedures used in constructing decision trees. For instance, data preparation methods have included augmenting training data with adversarial examples to improve resilience against malicious inputs and cleaning training data to remove potentially harmful examples. Procedural adjustments have included, for example, simplifying tree structures during training to prevent overfitting and creating collections of trees trained on slightly altered versions of training data in an effort to increase stability.

Despite these techniques being helpful in improving decision tree robustness in some contexts, developers and security experts are still lacking solutions for effectively hardening decision trees against adversarial manipulations and/or falsifications of input data. Consequently, there remains a significant need for systems and methods that can effectively protect decision trees and their corresponding applications against adversarial attacks, regardless of whether the attacks originate at the data source or are executed after the data is collected.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure can be implemented as a method for generating a robust decision tree. An example method is performed by one or more processors of a computing system. The example method can include receiving, over a communications network from a computing device, a transmission including a dataset including a set of features, generating a trustworthiness score for each respective feature of the set of features, each trustworthiness score indicative of at least one of a degree of reliability associated with a source of the respective feature or a degree of difficulty associated with manipulating values for the respective feature, and generating a robust decision tree for the dataset based on the set of features and their corresponding trustworthiness scores.

Another innovative aspect of the subject matter described in this disclosure can be implemented in a computing system for generating a robust decision tree. An example system includes one or more processors and at least one memory coupled to the one or more processors and storing instructions that, when executed by the one or more processors, cause the system to perform operations. The operations can include receiving, over a communications network from a computing device, a transmission including a dataset including a set of features, generating a trustworthiness score for each respective feature of the set of features, each trustworthiness score indicative of at least one of a degree of reliability associated with a source of the respective feature or a degree of difficulty associated with manipulating values for the respective feature, and generating a robust decision tree for the dataset based on the set of features and their corresponding trustworthiness scores.

Another innovative aspect of the subject matter described in this disclosure can be implemented as a non-transitory computer-readable medium storing instructions that, when executed by one or more processors of a system for generating a robust decision tree, cause the system to perform operations. Example operations include receiving, over a communications network from a computing device, a transmission including a dataset including a set of features, generating a trustworthiness score for each respective feature of the set of features, each trustworthiness score indicative of at least one of a degree of reliability associated with a source of the respective feature or a degree of difficulty associated with manipulating values for the respective feature, and generating a robust decision tree for the dataset based on the set of features and their corresponding trustworthiness scores.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example computing system, according to some implementations.

FIG. 2 shows an example process flow for generating a robust decision tree, according to some implementations.

FIG. 3 shows an example process flow for generating a robust decision tree, according to some implementations.

FIG. 4 shows an illustrative flowchart depicting an example operation for generating a robust decision tree, according to some implementations.

Like numbers reference like elements throughout the drawings and specification.

### DETAILED DESCRIPTION

As described above, artificial intelligence (AI) is rapidly transforming numerous fields through its ability to perform complex tasks, and AI-based applications often use decision trees for modeling and prediction. However, decision trees are vulnerable to adversarial attacks that can compromise their reliability and security. Conventional mitigation techniques have focused on data preparation and procedural adjustments and have offered minimal protection against adversarial manipulations and/or falsifications of input data. Specifically, conventional mitigation techniques have failed to consider the trustworthiness of input features during decision tree generation. This inadequate consideration of input feature trustworthiness significantly compromises the reliability of decision trees in AI-based applications. Because decision tree models are generated based on patterns and relationships extracted from feature data, if the input data is inaccurate and/or manipulated, the AI application (and any predictions or classifications it makes based on the decision tree) inherits these flaws, which can lead to inaccurate outputs or even harmful or misleading decisions. As an example, an AI-based application may incorporate decision trees to predict bird migration patterns. If the decision trees are largely generated based on unverifiable, self-reported data from public sources (e.g., where users misreport food availability or misidentify species), the application may incorrectly predict that birds will remain in northern habitats when they actually need to migrate, which could result in misdirected conservation efforts and endangering migratory species. Accordingly, there is a need for intelligent systems and methods that can effectively balance robust security of decision trees against adversarial attacks with the preservation of desired decision tree accuracy.

Aspects of the present disclosure provide innovative systems and methods for generating robust decision trees. The various systems and methods disclosed herein consider the trustworthiness of each feature (e.g., a reliability of each feature's source and/or a difficulty of manipulating values for each feature) when generating decision trees, and can be deployed, for example, to increase the reliability of the applications in which the decisions trees are integrated. For purposes of discussion herein: an “instance” is a single, specific data point or observation within a dataset (e.g., represented by a feature vector, i.e., a collection of values corresponding to various features); a “feature” (or “attribute”) is an individual measurable property or characteristic of an instance (e.g., used to distinguish between or categorize instances); a “dataset” is a collection of instances organized for processing in a table or matrix where rows represent instances and columns represent features (e.g., such that each instance is described by a set of features with corresponding attribute values); a “decision tree” is a hierarchical model used (e.g., in an AI-based application) for decision-making, prediction, or classification that is generated by recursively partitioning a dataset based on feature values such that homogeneous groups are created in terminal nodes with respect to a target variable; a “target variable” in the context of a decision tree is a categorical or numeric value that the decision tree is trying to predict (e.g., the outcome to be forecast, classified as categorical or numerical, or regressed to based on the features); a “node” within a decision tree is a point representing either a decision point (“decision node”) or an outcome (“terminal node”); a “decision node” is a specific type of node that applies a splitting criterion to divide instances into subgroups; “splitting a node” refers to dividing a decision node into two or more child nodes based on the value of a selected feature such that the homogeneity or “purity” of the resulting child nodes is improved with respect to the target variable; a “split point” (or “splitting value”) refers to the threshold or condition used within a decision node to determine the division of instances based on the value of a feature; a “branch” in a decision tree is a path connecting one node to another (e.g., a possible decision path); a “terminal node” (or “leaf node”) is an endpoint (i.e., with no child nodes) of a branch in a decision tree (e.g., where a final decision, classification, or predicted value for the target variable is assigned based on the instances reaching that node); an “attack” refers to an attempt by any entity, whether human or automated, to manipulate or falsify source data used in generating decision trees and/or to manipulate or falsify existing data (e.g., already received from a source) that may be used in generating decision trees; and a “source” is any origin of feature data used in generating decision trees, such as databases, sensors, user-provided input, application programming interfaces (APIs), or the like.

A computing system may be used to perform the various operations of the systems and methods disclosed herein. In accordance with the innovative techniques disclosed herein, upon receiving a set of features, the computing system may generate a trustworthiness score for each of the features. Each trustworthiness score may be indicative of a degree of reliability associated with a source of the feature and/or a degree of difficulty associated with manipulating values for the respective feature. Thereafter, the computing system may generate a robust decision tree based on the features and their trustworthiness scores.

In these and other manners, the computing system described herein provides several technical benefits over conventional solutions for generating robust decision trees. By considering the trustworthiness of features during decision tree construction, the system enhances model robustness against adversarial manipulations, improves the reliability of predictions, reduces the impact of potentially compromised data, and ensures more secure and reliable ML applications. By giving more weight to features inherently resistant to tampering, the system enhances its resilience against adversarial attacks, strengthens overall security, and reduces the risk of malicious manipulation leading to incorrect decision tree outcomes. By dynamically evaluating and prioritizing features based on their trustworthiness, the system enhances the accuracy of predictions under adversarial conditions, provides a more robust and reliable decision-making process, and ensures more secure and reliable ML applications while assisting engineers in developing robust models. By assessing and integrating feature trustworthiness into the decision tree construction process, the system ensures more secure and reliable ML applications, promotes greater confidence in the integrity of decision-making results, and generates robust decision trees that partition data such that the homogeneity of the child nodes is maximized while also maximizing an extent to which the robust decision tree is resistant to adversarial attacks on the data used to generate the robust decision tree. By considering the reliability and potential manipulation of input features when making decisions, the system enhances its resilience against adversarial attacks, increases security by mitigating the impact of manipulated inputs, and assists engineers and/or application developers in building more secure and trustworthy AI-based applications.

Aspects of the subject matter disclosed herein are not an abstract idea such as a mental process that can be performed in the human mind. For example, the human mind is not capable of receiving a transmission over a communications network (e.g., the Internet) from a computing device. Further, the human mind is not capable of generating nor integrating with decision trees used in AI-based applications. While a simple, hand-drawn decision tree might be conceivable to manage manually, the present subject matter leverages extremely complex trees with hundreds or even thousands of nodes, incorporating a vast array of factors, weighted probabilities, multilayered conditional dependencies, context-aware adjustments handled by ML algorithms, and potentially constantly updated data. Integrating with and processing this level of complexity is far beyond human capability. The human mind cannot calculate probabilities across so many branches, nor can the human mind integrate and analyze real-time data to dynamically adjust a decision tree based on the latest information and/or individual input responses. Moreover, determining a trustworthiness of features and generating corresponding robust decision trees requires analyzing massive datasets to evaluate the features and to determine optimal splitting criteria, which is a task that requires computational analysis of data and sophisticated statistical techniques (e.g., cross-validation and significance testing) far exceeding human capacity. In addition, aspects of the subject matter disclosed herein are not an abstract idea such as a method of organizing human activity because the claims of this patent application do not recite any fundamental economic practice, commercial interaction, legal interaction, or business relations. Moreover, various implementations of the subject matter disclosed herein provide technical solutions to the technical problem of improving the capability and functionality (e.g., speed, accuracy, etc.) of computer-based systems, where the technical solutions can be practically and practicably applied to improve on existing techniques for generating decision trees. Implementations of the subject matter disclosed herein provide specific inventive steps describing how desired results are achieved and realize meaningful and significant improvements on existing computer functionality—that is, the performance of computer-based systems operating in the evolving technological field of decision tree generation.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

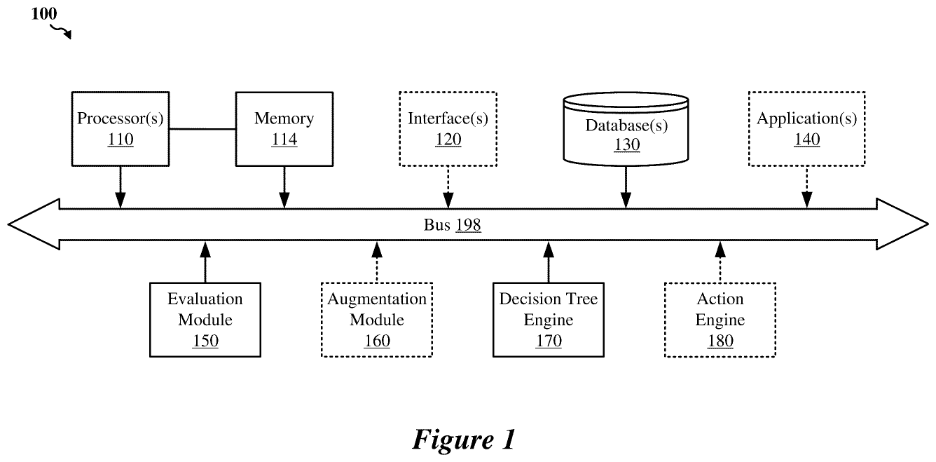

FIG. 1 shows an example computing system 100, according to some implementations. Various aspects of the computing system 100 disclosed herein are generally applicable for generating robust decision trees. The computing system 100 includes a combination of one or more processors 110, a memory 114 coupled to the one or more processors 110, one or more interfaces 120, one or more databases 130, one or more applications 140, an evaluation module 150, an augmentation module 160, a decision tree engine 170, and/or an action engine 180. In some implementations, the computing system 100 does not include one or more components illustrated in FIG. 1, such as the interface(s) 120, the application(s) 140, the augmentation module 160, and/or the action engine 180. In some implementations, the various components of the computing system 100 are interconnected by at least a data bus 198. In some other implementations, the various components of the computing system 100 are interconnected using other suitable signal routing resources.

The processor 110 includes one or more suitable processors capable of executing scripts or instructions of one or more software programs stored in the computing system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more hardware accelerators for processing a large amount of data and/or one or more artificial intelligence (AI) accelerators for accelerating AI and machine learning (ML)-based operations, such as one or more graphics processing units (GPUs), one or more tensor processing units (TPUs), one or more neural processing units (NPUs), a wafer-scale integration (WSI) architecture, or the like. For example, the processor 110 may use hardware-based TPUs to process and/or adjust millions, billions, or trillions of artificial neural network (ANN) parameters within seconds, milliseconds, or microseconds.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

One or more input/output (I/O) interfaces (e.g., the interface 120) may be used for transmitting or receiving (e.g., over a communications network) transmissions, input data, and/or instructions to or from a computing device (e.g., associated with a user of the system 100), outputting data (e.g., over the communications network) to the computing device, or the like. In an example implementation, the interface 120 receives a transmission over a communications network (e.g., the Internet) and provides the evaluation module 150 with a set of features associated with a dataset embedded within the transmission. The interface 120 may also be used to transmit communications to the user's computing device, which may include a robust decision tree generated for the dataset. The interface 120 may also be used to provide or receive other suitable information, such as computer code for updating one or more programs stored on the computing system 100, internet protocol requests and results, or the like. An example interface includes a wired interface or wireless interface to the Internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the computing system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the computing system 100 by a local user or moderator.

The database 130 may store data associated with the computing system 100, such as transmissions, datasets, features, instances, attributes, values, variables, scores, degrees or measures (or other suitable quantities), decision trees, engines, classifiers, models, predictions, formulas, among other suitable information. In various implementations, the database 130 may also store metrics, input, output, queries, responses, requests, application information, instructions, user data, configurations, thresholds, metadata, data associated with attacks and mitigation techniques, data associated with changes, events, change data capture (CDC) information, event bus (EB) information, filters, data assets, preferences, priorities, timestamps, models, algorithms, modules, engines, user information, historical data, recent data, current or real-time data, files, plugins, arrays, tags, queries, feedback, insights, formats, features, among other suitable information. In various implementations, the database 130 stores data associated with ANN models, such as the models themselves, untrained models, pretrained models, tuned models, aligned models, reward models, NN parameters (e.g., weights, biases, tensors, parameters), architectures (e.g., layer descriptions, neurons, activation functions, overall structures), training data and related information (e.g., statistics, distribution, size, preprocessing steps, training data, text corpora, tuning data, alignment data, alignment data snapshots, alignment preferences, metric logs, accuracies, loss functions and values), hyperparameters (e.g., learning rates, batch sizes, numbers of epochs), evaluation results (e.g., performance metrics and models, validation data, test sets, benchmark scores, thresholds, receiver operating characteristic (ROC) curves, confusion matrices), versioning information (e.g., iterations, updates), metadata and documentation (e.g., usage instructions, authors), deployment configurations (e.g., settings for deploying models in different environments), monitoring data (e.g., real-time or periodic tracking performance in production), or any other suitable data related to ANN models. In various implementations, the database 130 may store data in one or more cloud object storage services, such as one or more Amazon Web Services (AWS)-based Simple Storage Service (S3) buckets. In various implementations, the database 130 incorporates one or more aspects of a database management system (DBMS) or a relational DBMS (RDBMS). In various implementations, the data may be stored in one or more JavaScript Object Notation (JSON) files, comma-separated values (CSV) files, or any other suitable data objects for processing by the computing system 100. In some implementations, the data may be stored in one or more Structured Query Language (SQL) compliant datasets for filtering, querying, and sorting, or any other suitable format for processing by the computing system 100. In various implementations, the database 130 includes a relational database capable of presenting information as datasets in tabular form and capable of manipulating the datasets using relational operators.

The one or more applications 140 may each include one or more interconnected modules or components that interact with each other to perform one or more functions or tasks, such as providing a desired functionality to a user. In various implementations, the application 140 integrates one or more aspects of ML, deep learning (DL), or AI to provide predictive capabilities, personalized recommendations, decision-making automation, or the like. For instance, each of the applications 140 may integrate at least one decision tree to perform various AI-based tasks, such as classifying user preferences, predicting equipment failure, optimizing resource allocation, detecting anomalies, segmenting users, generating recommendations, supporting real-time decision-making, identifying fraudulent transactions, predicting churn, classifying inquiries, or any number of other non-limiting examples. For purposes of discussion herein, integrating a decision tree into the application 140 may include embedding a computational model as a component of the application's logic, such as to enable the application 140 to use the decision tree to generate classifications and/or predictions based on mapping input features to specific outputs. In various implementations, the application 140 may have a monolithic architecture, a microservices architecture including a plurality of services coupled via one or more application programming interfaces (APIs), and/or a distributed architecture across a plurality of processes and/or machines and network protocols. In various implementations, the application 140 may integrate with one or more external systems or services (e.g., via APIs) to enable the application 140 to interact with one or more third-party gateways, services, or platforms. In various implementations, the application 140 may be deployed on a variety of hardware platforms, mobile devices, embedded systems, or cloud servers, and may incorporate one or more CPUs, GPUs, FPGAs, sensors, or other specialized hardware and/or AI-based accelerators to optimize performance for specific tasks. In various implementations, the application 140 may be developed based on a variety of programming languages and frameworks, such as Python, Node.js, Java, React.js, Angular, Flutter, or another suitable language or framework. In various implementations, the application 140 is hosted on a cloud platform (e.g., Amazon Web Services (AWS) or Azure) and/or an on-premise infrastructure (e.g., the database 130). In various implementations, the application 140 incorporates one or more security mechanisms, such as an authentication mechanism (e.g., multi-factor authentication (MFA)), data encryption (e.g., in transit and at rest), audit logging, an AI firewall, or the like.

The evaluation module 150 may be used to generate trustworthiness scores for a set of features included in a dataset. The evaluation module 150 may receive the dataset over a communications network (e.g., the Internet), such as from a computing device associated with a user of the computing system 100. The dataset may include a plurality of instances and, for each of the instances, an attribute value for at least one of the features. The dataset may further include a target variable and, for each of the instances, a target value for the target variable. As a simplified example: the dataset may relate to identifying types of flowers based on their physical characteristics; each instance in the dataset may represent an individual flower; for each instance, the dataset may include attribute values for features (e.g., petal length, petal width, sepal length, and sepal width); the target variable may be the species of the flower (e.g., iris setosa, iris versicolor, or iris virginica); and for each instance, the target value may specify the species of the corresponding flower. Once received, the evaluation module 150 may generate a trustworthiness score for each respective feature of the set of features. In some implementations, each trustworthiness score is indicative of a degree of reliability associated with a source of the respective feature, a degree of difficulty associated with manipulating values for the respective feature, or both.

With respect to the difficulty associated with manipulating values for a respective feature, the evaluation module 150 may determine the degree of difficulty based in part on a degree of complexity associated with modifying an existing value for the respective feature. In some implementations, the degree of complexity may be represented by a “controllability complexity score” (CCS) that quantifies an extent of difficulty that an attacker would have in manipulating the feature.

As non-limiting examples of CCS, a first example feature may be a user's physical address. If users are allowed to update their physical address without any verification (e.g., by simply entering a new address in their profile and saving it), the CCS for this example feature may be relatively low. However, if additional steps are required for users to change their physical address (e.g., verifying the address through a mailed confirmation code or cross-checking with a trusted database), the CCS for this example feature may be relatively high. As another example, a user's preferred display name feature may have a low CCS if it can be modified easily without validation. As other examples, a feature associated with a locally stored account creation timestamp or third-party authentication data (e.g., the user's identity being verified via government-issued ID or a biometric system) may have a much higher CCS due to the high complexity involved in altering or spoofing such information. In some implementations, the CCS is predefined for each feature, such as by a developer and/or security expert. In some other implementations, the evaluation module 150 is configured to define the CCS for each feature, such as by analyzing historical manipulation attempts, assessing the required effort for modification based on system logs, and evaluating the level of verification or authentication required for changes. In various implementations, one or more ML models may be trained on historical data to dynamically determine a CCS for each feature based on various factors, such as a frequency of changes and/or a method of data modification.

With respect to the reliability associated with a source of a respective feature, the evaluation module 150 may determine the degree of reliability based in part on a degree of expertise associated with falsifying an initial value for the respective feature, a degree of resources associated with falsifying an initial value for the respective feature, or both. In some implementations, the degree of reliability may be represented by a “source trustworthiness level score” (STLS) that quantifies the trustworthiness of a data source based on an assessment of manipulation techniques an attacker may use to manipulate the data source.

As non-limiting examples of STLS, features and attribute values obtained from public data sources (or data sources otherwise deemed generally untrustworthy) may be assigned relatively lower STLS due to the ease with which their information can be manipulated. In contrast, features and attribute values obtained from protected internal databases or particular third-party sources (e.g., a data enrichment provider) may be deemed trustworthy and more reliable and thus assigned relatively higher STLS. As another example, feature data may be obtained via an application that collects browser information when users log in. However, this feature may be highly susceptible to manipulation with minimal expertise, such as using an extension to report a browser other than the one actually in use (e.g., reporting Safari when the user is on Chrome), and thus may be associated with a relatively low STLS. By contrast, an IP address feature may have varying levels of trustworthiness and thus varying levels of STLS depending on the source. For instance, if the IP address feature originates from a public source or could be easily masked using a VPN, the feature may be assigned a low STLS. However, if the IP address feature is verified through a trusted vendor with robust mechanisms to prevent spoofing, the feature may be assigned a high STLS. As yet another example, feature data obtained from a direct customer may be associated with a higher STLS than feature data obtained from an indirect customer (e.g., customers of a direct customer), as the latter involves an additional layer of potential unreliability. Furthermore, higher STLS may be assigned to features that require significant resources and expertise to falsify. For example, a user being required to purchase a new phone and SIM card (i.e., relatively high resource requirement) to falsify a feature may significantly increase the STLS for the feature. As another example, because fabricating an SSN or similar ID requires a relatively high level of expertise, such features may also have relatively higher STLS. In some implementations, the STLS is predefined for each feature, such as by a developer and/or security expert. As a simplified example, the quantified degree values for each feature may be stored in a table where a classification is selected for “Required Attack Cost/Resource” (None, Low, Moderate, High, Very High), a classification is selected for “Expertise” (Basic, Limited, Modest, Significant, Advanced), and the intersection of the classifications is assigned a corresponding value within a range (e.g., 1-10). For this example, features associated with “None” and “Basic” above may have a score of 1, and features associated with “Very High” and “Advanced” above may have a score of 10. In some other implementations, the evaluation module 150 is configured to define the STLS for each feature, such as by automatically completing the table described above and/or by analyzing any number of factors related to potential attackers for each feature (e.g., technical background requirements, attack tool proficiency requirements, coding or hacking experience requirements, cost implications, general knowledge requirements, and the like). In various implementations, one or more ML models are trained on historical data and feature metadata to dynamically determine a STLS for each feature (e.g., in real-time).

In some implementations, the evaluation module 150 generates each trustworthiness score based on a combination of the degree of difficulty (CCS) and the degree of reliability (STLS) described above. In some instances, a combination of the degree of reliability and the degree of difficulty may incorporate one or more custom weights. Specifically, a CCS and an STLS may be determined for each feature, and a final trustworthiness score may be determined for each feature based on a custom weight assigned to each of the CCS and the STLS. As a non-limiting example, a custom weight of 0.4 may be selected for the CCS and a custom weight of 0.6 may be selected for the STLS, such as if a developer and/or security expert deems the STLS slightly more pertinent to the reliability of feature values than the CCS. For this example, if the CCS for a given feature is 84 and the STLS for the given feature is 23, the final trustworthiness score for the given feature may be (84) (0.4)+(23)(0.6)=47.4. In this manner, a trustworthiness of features is evaluated based on a reliability of their source and a complexity of manipulating their values, thereby increasing robustness of decision trees generated using values for those features, enhancing security against adversarial attacks, and ensuring more reliable ML applications integrating the robust decision trees, as further described below.

The augmentation module 160 may be used to augment the decision tree engine 170 such that robust decision trees are generated based on the trustworthiness scores generated by the evaluation module 150. As described above, the trustworthiness scores are generated based on a set of features included in a dataset, where the dataset includes a plurality of instances and, for each of the instances, an attribute value for at least one of the features, and further includes a target variable and, for each of the instances, a target value for the target variable. Once generated, the robust decision tree may be used to predict a target variable for new instances based on their attribute values. In various implementations, the decision tree engine 170 is an ML-based decision tree engine that incorporates one or more aspects of at least one of a random forest classifier, an XGBoost regressor, an AdaBoost classifier, or a gradient boosting technique. The augmentation module 160 may augment the decision tree engine 170 such that a higher trustworthiness score for a given feature increases a likelihood that the decision tree engine 170 will select the given feature to split the dataset in the robust decision tree, and such that a lower trustworthiness score for a given feature decreases the likelihood that the decision tree engine 170 will select the given feature to split the dataset in the robust decision tree.

Specifically, prior to augmentation, when selecting a feature to use when splitting each node in a decision tree (e.g., in an effort to partition the data such that the homogeneity of the child nodes is maximized), the decision tree engine 170 may determine an impurity measure for each feature. In some instances, the pre-augmented impurity (or “inequality”) measure may be a Gini index. In some other instances, the pre-augmented impurity measure may be an information gain value, a misclassification error rate, a variance reduction, or the like. When the pre-augmented impurity measure is the Gini index, the decision tree engine 170 may determine an impurity measure for a given feature based on the following formula:

$$G = 1 - {\sum }_{i = 1}^{m} {p}_{i}^{2} ,$$

where G is the Gini index for the given feature (i.e., quantifying the level of uncertainty or randomness in the dataset if it were split based on that feature), m is the number of features (or categories) in the target variable, and p is the proportion of samples (i.e., belonging to feature i) in the dataset or node being evaluated. In this manner, the Gini index evaluates how often a randomly chosen element would be incorrectly classified if it was randomly labeled according to the distribution of features, where a lower Gini index indicates a purer node (e.g., all samples in one feature) and a higher Gini index indicates greater impurity. It will be appreciated that the pre-augmented impurity measure (e.g., the Gini index) does not consider the trustworthiness of the features when measuring their impurity.

In some implementations, the augmentation module 160 has previously been used to augment the decision tree engine 170. Accordingly, upon generating trustworthiness scores for a set of features in a dataset, the evaluation module 150 may proceed to feed the set of features and the trustworthiness scores to the decision tree engine 170, and the decision tree engine 170 may generate a robust decision tree based on the set of features and the trustworthiness scores.

Specifically, after augmentation, the impurity measure operation performed by the decision tree engine 170 gives more importance to features with higher trustworthiness scores. Specifically, once augmented, the decision tree engine 170 uses the trustworthiness scores to determine a measure of impurity for each feature and thus incorporates the trustworthiness scores when selecting an optimum feature to use when splitting each node in the decision tree, thereby partitioning the data such that the homogeneity of the child nodes is maximized while also maximizing an extent to which the robust decision tree is resistant to adversarial attacks. The decision tree engine 170 may determine an impurity measure for a given feature based on a formula that incorporates the trustworthiness score generated for the given feature and a sum of the trustworthiness scores generated for the entire set of features. As a non-limiting example, the formula may be an augmented Gini index formula, such as

$${G}_{□} = 1 - {\sum }_{i = 1}^{m} ( \frac{{s}_{i} * {p}_{i}}{{\sum }_{j = 1}^{m} {s}_{j}} ) ,$$

where [symbol] is the augmented Gini index for the given feature, m is the number of features (or categories) in the target variable, p is the proportion of samples (i.e., belonging to feature i) in the dataset or node being evaluated, [symbol] is the trustworthiness score generated for feature i, and [symbol] is the sum of all feature scores generated for all of the features. To note, by summing and normalizing the feature scores to ensure they sum to one, a relative importance of each feature is preserved, e.g., preventing all relatively high trustworthy scores from being equally weighted as highly trustworthy (and vice versa). In some other implementations, the augmented impurity measure may combine the trustworthiness scores with aspects of a different impurity measure (e.g., an information gain value, a misclassification error rate, a variance reduction, or any suitable custom measurement of selection probability) in a different manner. By accounting for both the inherent probability of selection and the trustworthiness of each feature, the augmented impurity measure provides a distribution of selections and a weighted trustworthiness significance of each feature, thereby resulting in a more trustworthy and resilient decision tree.

Accordingly, the robust decision tree generated by the augmented decision tree engine 170 includes at least one decision node that splits the dataset based on a selected one of the features, where the one of the features is selected based in part on the trustworthiness scores generated for the features. Specifically, in generating the robust decision tree, the augmented decision tree engine 170 may determine, for each respective decision node, an impurity measure for each feature based on the trustworthiness scores, and select the one of the features associated with a lowest impurity measure to split the dataset at the respective decision node. The augmented decision tree engine 170 may also use the impurity measures (and thus the trustworthiness scores) to identify an optimum split point within the selected feature for each decision node. The augmented decision tree engine 170 may also use the impurity measures (and thus the trustworthiness scores) to define at least two terminal nodes for each robust decision tree.

In these and other manners, a weighted adjustment (i.e., based on trustworthiness scores assigned to the features) to standard impurity or variance measures is incorporated into the generation of decision trees. Accordingly, features derived from reliable and secure sources (i.e., more resistant to manipulation) are assigned higher trustworthiness scores and are thus prioritized in the splitting process. By contrast, features from less controlled or less secure sources are subjected to greater scrutiny and are deprioritized in the splitting process. As a simplified non-limiting example, features may include the age of a driver, a gender of the driver, and a number of previous incidents associated with the driver, and the decision tree may be used to classify drivers into groups with either a high or low likelihood of future incidents (e.g., for insurance purposes). Although the feature associated with the number of previous incidents may be selected to split the data when the Gini Index is used as an impurity measure, if the data associated with the number of previous incidents originates from an unreliable source, the augmented Gini Index may indicate that one of the other features (e.g., age or gender) provides a more trustworthy basis for splitting while still maintaining an acceptable level of purity. Accordingly, the augmented decision tree engine 170 prioritizes the more reliable feature, thereby ensuring that the resulting splits are both robust and secure.

The action engine 180 may be used to perform one or more actions using the robust decision tree generated by the decision tree engine 170. For instance, the decision tree engine 170 may generate the robust decision tree in a structured computational format, such as an in-memory data structure (e.g., a directed acyclic graph) or as serialized metadata, where the structured computational format indicates the hierarchical relationships between nodes in the decision tree and their associated parameters (e.g., selected features, split points, thresholds, impurity measures, terminal nodes, output predictions or classifications, and the like). Thereafter, the action engine 180 may integrate the robust decision tree into one or more of the applications 140. As one example, the application 140 may be an account takeover model that uses the robust decision trees to determine whether a user account is under threat of takeover in real-time. As another example, the application 140 may be a synthetic account sign-up detection model that uses the robust decision trees to detect whether a user sign-up includes fraudulent information. In some implementations, the process of integrating one or more robust decision tree(s) into one of the applications 140 may include, for example, retrieving (e.g., via a transmission) the representation of the robust decision tree (e.g., the structured computational format), exporting and/or transforming the representation into a machine-readable format (e.g., JSON, XML, or the like) indicating the parameters of the decision tree (e.g., decision nodes, branches, split points, outcomes or predictions at terminal nodes, and the like), importing the transformation into the application 140 (e.g., the source code, a library, a module, or the like), and configuring one or more runtime evaluation routines of the application 140 that define how the imported robust decision trees are to be used by the application 140 in processing new data.

The database 130, the evaluation module 150, the augmentation module 160, the decision tree engine 170, and the action engine 180, are implemented in software, hardware, or a combination thereof. In some implementations, any one or more of the database 130, the evaluation module 150, the augmentation module 160, the decision tree engine 170, or the action engine 180 is embodied in instructions that, when executed by the processor 110, cause the computing system 100 to perform operations. In various implementations, the instructions of one or more of said components, the application(s) 140, and/or the interface 120 are stored in the memory 114, the database 130, or a different suitable memory, and are in any suitable programming language format for execution by the computing system 100, such as by the processor 110. It is to be understood that the particular architecture of the computing system 100 shown in FIG. 1 is but one example of a variety of different architectures within which aspects of the present disclosure can be implemented. For example, in some implementations, components of the computing system 100 are distributed across multiple devices, included in fewer components, and so on. While the below examples related to generating a robust decision tree are described with reference to the computing system 100, other suitable system configurations may be used.

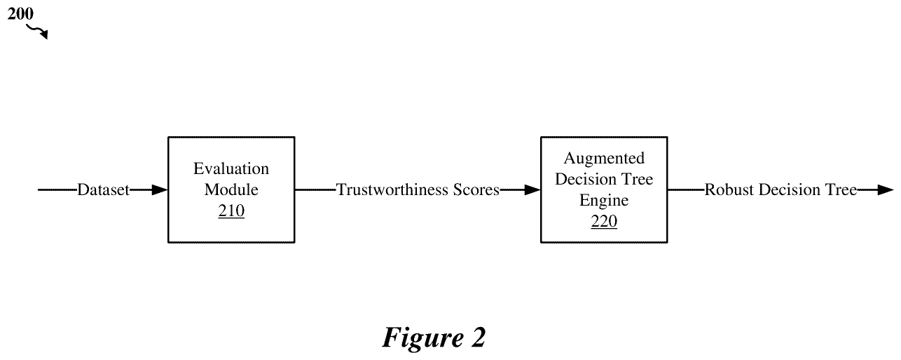

FIG. 2 shows an example process flow 200 for generating a robust decision tree, according to some implementations, and may be performed by one or more processors of a computing system, such as the computing system 100 described with respect to FIG. 1. The example process flow 200 shows an evaluation module 210 and an augmented decision tree engine 220, which may be examples of the evaluation module 150 and of the decision tree engine 170 described with respect to FIG. 1, respectively.

The example process flow 200 starts with the evaluation module 210 receiving a dataset. The dataset may include at least a set of features. In accordance with the innovative techniques described herein, the evaluation module 210 generates a trustworthiness score for each of the features. The trustworthiness scores may be provided to the augmented decision tree engine 220. In accordance with the innovative techniques described herein, the augmented decision tree engine 220 may be used to generate a robust decision tree for the dataset based at least on the trustworthiness scores.

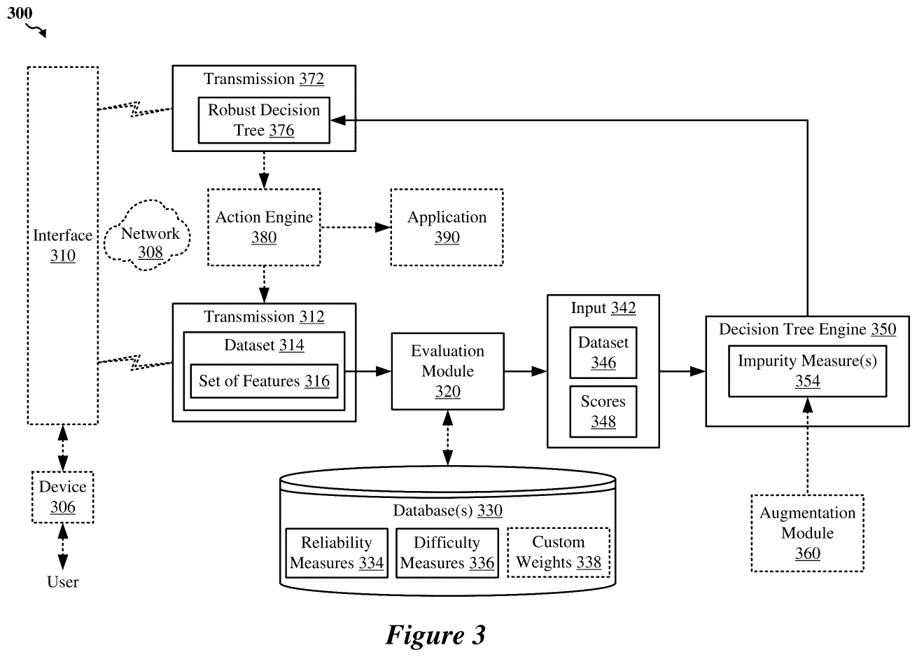

FIG. 3 shows an example process flow 300 for generating a robust decision tree, according to some implementations, and may be performed by one or more processors of a computing system, such as the computing system 100 described with respect to FIG. 1. The example process flow 300 shows an interface 310, an evaluation module 320, one or more databases 330, a decision tree engine 350, an augmentation module 360, an action engine 380, and an application 390, which may be examples of the interface 120, the evaluation module 210, the database 130, the augmented decision tree engine 220, the augmentation module 160, the action engine 180, and the application 140, respectively, described with respect to FIG. 1 and FIG. 2.

The example process flow 300 starts with receiving a transmission 312. In some implementations, the transmission 312 is received via the interface 310, such as over a communications network 308 (e.g., the Internet or an intranet), from a computing device 306, which may be associated with a user of the computing system 100. In some other implementations, the transmission 312 is received from the action engine 380, such as in an automated system used for generating robust decision trees for features associated with one or more applications. The transmission 312 may include a dataset 314, which may include a set of features 316. The transmission 312 may be received by, or otherwise provided to, the evaluation module 320.

The example process flow 300 continues with the evaluation module 320 generating a trustworthiness score for each respective feature of the set of features 316. In generating the trustworthiness scores, the evaluation module 320 may determine a degree of reliability associated with a source of each respective feature, such as based on a set of reliability measures 334. In some implementations, the reliability measures 334 are retrieved from the database 330. In some other implementations, the evaluation module 320 dynamically determines the degrees of reliability and stores them in the database 330. Further in generating the trustworthiness scores, the evaluation module 320 may determine a degree of difficulty associated with manipulating values for each respective feature, such as based on a set of difficulty measures 336. In some implementations, the difficulty measures 336 are retrieved from the database 330. In some other implementations, the evaluation module 320 dynamically determines the degrees of difficulty and stores them in the database 330. Thereafter, the evaluation module 320 generates a trustworthiness score for each respective feature of the set of features 316 based on a combination of the degree of reliability and the degree of difficulty determined for the respective feature. In some instances, the combination of the degree of reliability and the degree of difficulty incorporates one or more custom weights 338. The evaluation module 320 may provide the dataset 314 (as dataset 346) and the trustworthiness scores (as scores 348) as input 342 to the decision tree engine 350. The scores 348 may also include a sum of the trustworthiness scores generated for the set of features 316.

The example process flow 300 continues with the decision tree engine 350 generating a robust decision tree 376 based on the input 342. The decision tree engine 350 may be augmented (at a prior time or in real-time) by the augmentation module 360, such as in one or more of the manners described with respect to FIG. 1. In generating the robust decision tree 376, the augmented decision tree engine 350 may determine, for each feature, an impurity measure 354 based in part on the scores 348. Specifically, the augmented decision tree engine 350 may determine, for each respective decision node in the robust decision tree 376, an impurity measure for each of the features 316 based on the scores 348, and select the one of the features 316 associated with a lowest impurity measure to split the dataset 346 at the respective decision node. In some implementations, the impurity measure 354 for a given feature may be determined based in part on the trustworthiness score generated for the given feature and a sum of the trustworthiness scores generated for the set of features 316. In these manners, the robust decision tree 376 partitions the dataset 314 such that a homogeneity of its child nodes is maximized while also maximizing an extent to which the robust decision tree 376 is resistant to adversarial attacks (e.g., on the set of features 316). The robust decision tree 376 may be output in a transmission 372.

In some implementations, the example process flow 300 continues with transmitting the transmission 372 via the interface 310 over the network 308 to the computing device 306. In such implementations, the user may utilize the robust decision tree 376 for any suitable purpose, such as for integration into an application or system for performing predictive analytics, enhancing decision-making, and/or automating workflows. In some other implementations, the example process flow 300 continues with transmitting the transmission 372 to the action engine 380. In such implementations, the action engine 380 may transform the robust decision tree 376 into a machine-readable format and integrate the transformation into an application 390. For instance, the application 390 may be an artificial intelligence (AI)-based application that uses the robust decision tree to perform various modeling and/or prediction tasks.

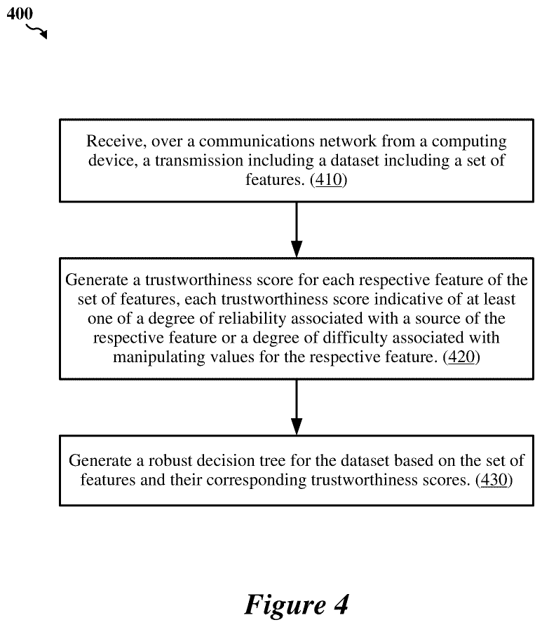

FIG. 4 shows an illustrative flowchart 400 depicting an example operation for generating a robust decision tree, according to some implementations, and may be performed by one or more processors of a computing system, such as the computing system 100 described with respect to FIG. 1. For example, at block 410, the computing system 100 receives, over a communications network from a computing device, a transmission including a dataset including a set of features. At block 420, the computing system 100 generates a trustworthiness score for each respective feature of the set of features, each trustworthiness score indicative of at least one of a degree of reliability associated with a source of the respective feature or a degree of difficulty associated with manipulating values for the respective feature. At block 430, the computing system 100 generates a robust decision tree for the dataset based on the set of features and their corresponding trustworthiness scores.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for generating a robust decision tree, the method performed by one or more processors of a computing system and comprising:
receiving, over a communications network from a computing device, a transmission including a dataset including a set of features;
generating a trustworthiness score for each respective feature of the set of features, each trustworthiness score indicative of at least one of a degree of reliability associated with a source of the respective feature or a degree of difficulty associated with manipulating values for the respective feature; and
generating a robust decision tree for the dataset based on the set of features and their corresponding trustworthiness scores.

2. The method of claim 1, wherein the dataset further includes a plurality of instances and, for each of the instances, an attribute value for at least one of the features.

3. The method of claim 2, wherein the dataset further includes a target variable and, for each of the instances, a target value for the target variable.

4. The method of claim 3, wherein the robust decision tree is used to predict the target variable for new instances based on their attribute values.

5. The method of claim 1, wherein the degree of reliability associated with the source of the respective feature is determined based in part on at least one of a degree of expertise associated with falsifying an initial value for the respective feature or a degree of resources associated with falsifying an initial value for the respective feature.

6. The method of claim 1, wherein the degree of difficulty associated with manipulating values for the respective feature is determined based in part on a degree of complexity associated with modifying an existing value for the respective feature.

7. The method of claim 1, wherein each trustworthiness score is based on a combination of the degree of reliability and the degree of difficulty.

8. The method of claim 7, wherein the combination of the degree of reliability and the degree of difficulty incorporates one or more custom weights.

9. The method of claim 1, wherein generating the robust decision tree includes feeding the set of features and the trustworthiness scores to a machine learning (ML)-based decision tree engine.

10. The method of claim 9, wherein the ML-based decision tree engine incorporates one or more aspects of at least one of a random forest classifier, an XGBoost regressor, an AdaBoost classifier, or a gradient boosting technique.

11. The method of claim 9, wherein the ML-based decision tree engine is augmented such that a higher trustworthiness score for a given feature increases a likelihood that the decision tree engine will select the given feature to split the dataset in the robust decision tree and such that a lower trustworthiness score for a given feature decreases the likelihood that the decision tree engine will select the given feature to split the dataset in the robust decision tree.

12. The method of claim 11, wherein the ML-based decision tree engine is augmented to use the trustworthiness scores to determine a measure of impurity for each feature.

13. The method of claim 12, wherein the measure of impurity is determined based on an augmented Gini index formula.

14. The method of claim 13, wherein the augmented Gini index formula determines a measure of impurity for a given feature based in part on the trustworthiness score generated for the given feature and a sum of the trustworthiness scores generated for the set of features.

15. The method of claim 9, wherein the ML-based decision tree engine is augmented to maximize an extent to which the robust decision tree can resist adversarial attacks.

16. The method of claim 1, wherein the robust decision tree includes at least one decision node that splits the dataset based on a selected one of the features.

17. The method of claim 16, wherein generating the robust decision tree includes:
determining, for each respective decision node, an impurity measure for each feature based on the trustworthiness scores; and
selecting the one of the features associated with a lowest impurity measure to split the dataset at the respective decision node.

18. The method of claim 17, wherein the impurity measures are further used to identify, for each decision node, an optimum split point within the selected feature.

19. The method of claim 17, wherein the impurity measures are further used to define at least two terminal nodes for the robust decision tree.

20. A system for generating a robust decision tree, the system comprising:
one or more processors; and
at least one memory coupled to the one or more processors and storing instructions that, when executed by the one or more processors, cause the system to perform operations including:
receiving, over a communications network from a computing device, a transmission including a dataset including a set of features;
generating a trustworthiness score for each respective feature of the set of features, each trustworthiness score indicative of at least one of a degree of reliability associated with a source of the respective feature or a degree of difficulty associated with manipulating values for the respective feature; and
generating a robust decision tree for the dataset based on the set of features and their corresponding trustworthiness scores.
